(19) United States
(12) Patent Application Publication
(10) Pub. No.: US 2024/0126671 A1
(43) Pub. Date: Apr. 18, 2024

(54) COMPUTER-READABLE RECORDING MEDIUM STORING PERFORMANCE MONITORING PROGRAM, PERFORMANCE MONITORING METHOD AND INFORMATION PROCESSING APPARATUS

(71) Applicant: Fujitsu Limited, Kawasaki-shi (JP)

(72) Inventor: Akira HIRAI, Kawasaki (JP)

(73) Assignee: Fujitsu Limited, Kawasaki-shi (JP)

(21) Appl. No.: 18/214,277

(22) Filed: Jun. 26, 2023

(30) Foreign Application Priority Data
Oct. 17, 2022 (JP) 2022-166490

(51) Int. Cl. G06F 11/34; G06F 11/30

(52) U.S. Cl. CPC G06F 11/3409; G06F 11/3024; G06F 11/3051

(57) ABSTRACT

A non-transitory computer-readable recording medium stores a performance monitoring program for causing a computer to execute processing including: in collection of a plurality of pieces of performance information of a processor when a program that operates in the processor is executed, associating and accumulating an operation characteristic of the program for each of the plurality of pieces of performance information; and selecting, in a case where the number of performance monitoring counters (PMCs) included in the processor is smaller than a total number of the plurality of pieces of performance information, performance information that has the operation characteristic of the program most separated from a current value of the operation characteristic of the program from the plurality of pieces of performance information, and allocating the performance information to the PMC.

### CROSS-REFERENCE TO RELATED APPLICATION

This application is based upon and claims the benefit of priority of the prior Japanese Patent Application No. 2022-166490, filed on Oct. 17, 2022, the entire contents of which are incorporated herein by reference.

### FIELD

The embodiment discussed herein is related to a performance monitoring program and the like.

### BACKGROUND

In recent years, a technology has been disclosed in which data of a plurality of pieces of performance information is collected, and the collected data is analyzed and used.

Japanese Laid-open Patent Publication No. 2017-45098, Japanese Laid-open Patent Publication No. 2014-149645, U.S. patent Ser. No. 10/678,805, and U.S. Patent Application Publication No. 2017/0085447 are disclosed as related art.

### SUMMARY

According to an aspect of the embodiments, a non-transitory computer-readable recording medium stores a performance monitoring program for causing a computer to execute processing including: in collection of a plurality of pieces of performance information of a processor when a program that operates in the processor is executed, associating and accumulating an operation characteristic of the program for each of the plurality of pieces of performance information; and selecting, in a case where the number of performance monitoring counters (PMCs) included in the processor is smaller than a total number of the plurality of pieces of performance information, performance information that has the operation characteristic of the program most separated from a current value of the operation characteristic of the program from the plurality of pieces of performance information, and allocating the performance information to the PMC.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a hardware configuration of an information processing apparatus according to an embodiment;

FIG. 2 is a diagram for describing a function of acquiring a central processing unit (CPU) pipeline resource use rate of a performance monitoring unit (PMU);

FIG. 3 is a diagram illustrating an example of a management table according to the embodiment;

FIG. 4 is a diagram illustrating an example of a state information current value according to the embodiment; and

FIGS. 5A and 5B are a diagram illustrating an example of a flowchart of performance monitoring processing according to the embodiment.

### DESCRIPTION OF EMBODIMENTS

Furthermore, a performance monitoring unit (PMU) mounted in a central processing unit (CPU) is used to perform performance analysis and detailed operation analysis of a system including an operating system (OS) and an application. There are several hundreds or more types of performance information collected by the PMU, for example, the number of CPU cycles, the number of execution instructions, the number of cache hits/misses, and the like. An information processing apparatus collects and integrally analyzes a large number of pieces of performance information during execution of a program operating in the CPU, thereby extracting a bottleneck of performance and using the extracted bottleneck for improving the performance of the program and eventually the system.

However, in a case where the performance monitoring unit (PMU) is used, there is a problem that it is difficult to collect the performance information without being affected by an operation status of the program operating in the CPU.

Such a problem will be described. There are several hundreds or more types of performance information that may be collected by the PMU, but the number of pieces of performance information that may be collected at the same time is limited. For example, one piece of performance information is collected by one performance monitoring counter (PMC). The number of PMCs is 2 to 8 in a common CPU. Therefore, in a case where the performance information in the number exceeding the number of PMCs is collected, the PMU switches the performance information allocated to the PMCs every predetermined period and collects the performance information.

When the program operating in the CPU is in a certain operation status, the PMC may acquire similar data regardless of a timing of acquiring specific performance information. However, in a case where the program operating in the CPU is not in the certain operation status, the data obtained by the PMC varies depending on the timing of acquiring the specific performance information. Therefore, in a case where the PMU is used, it is difficult to collect the performance information without being affected by the operation status of the program operating in the CPU.

In one aspect, an object of an embodiment is to collect performance information without being affected by an operation status of a program operating in a central processing unit (CPU).

Hereinafter, an embodiment of a performance monitoring program and a performance monitoring method disclosed in the present application will be described in detail with reference to the drawings. Note that the present disclosure is not limited by the embodiment.

### EMBODIMENT

[Hardware Configuration of Information Processing Apparatus]

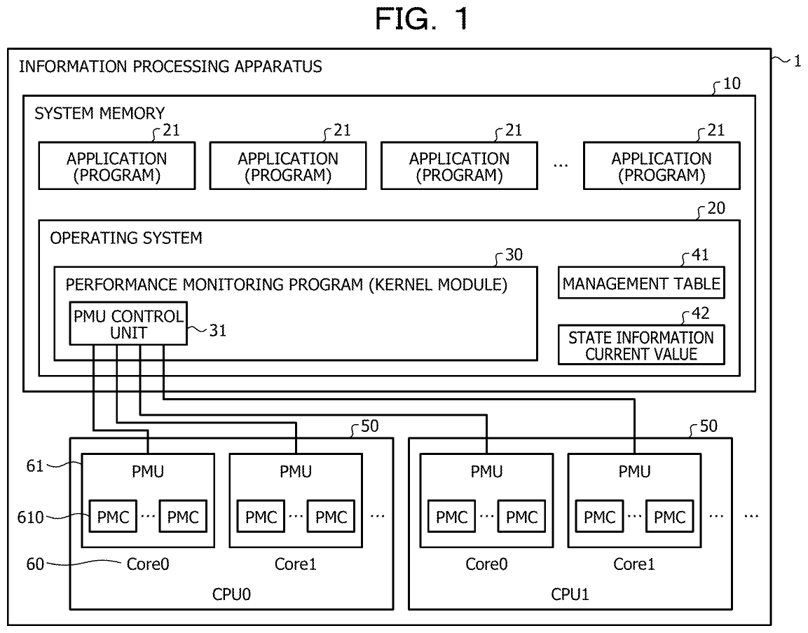

FIG. 1 is a diagram illustrating an example of a hardware configuration of an information processing apparatus according to the embodiment. As illustrated in FIG. 1, an information processing apparatus 1 includes a system memory 10 and central processing units (CPUs) 50.

The CPU 50 is coupled to the system memory 10 via a bus. The CPU 50 includes a plurality of cores 60. Note that the information processing apparatus 1 illustrated in FIG. 1 includes two CPUs 50, but is not limited to this, and may include three CPUs 50 or one CPU 50. Furthermore, the information processing apparatus 1 illustrated in FIG. 1 includes two cores 60 in one CPU 50, but is not limited to this, and may include three cores 60 or one core 60.

Each core 60 includes a performance monitoring unit (PMU) 61. The PMU 61 is a performance monitoring unit, and collects information regarding an event (hereinafter referred to as a performance information event) that occurs for performance information by using a performance monitoring counter (PMC) 610. There are several hundreds or more types of performance information collected by the PMU 61, for example, the number of CPU cycles, the number of execution instructions, the number of cache hits/misses, and the like. The PMU 61 includes a plurality of the PMCs 610. The PMC 610 refers to a performance monitoring counter. The number of PMCs 610 is, for example, 2 to 8, but varies depending on specifications of the CPU 50. Therefore, in a case where the performance information in the number exceeding the number of PMCs 610 is collected, for example, the PMU 61 switches the performance information allocated to the PMCs 610 in a time division manner and collects the performance information.

The system memory 10 includes an operating system 20 and applications 21. The operating system 20 includes a performance monitoring program 30, a management table 41, and a state information current value 42.

The performance monitoring program 30 is one of kernel modules. The performance monitoring program 30 uses the PMU 61 to monitor a plurality of types of performance of the core 60 on which the application 21 operates, when the application 21 operating on the core 60 of the CPU 50 is executed. The performance monitoring program 30 includes a PMU control unit 31. Note that processing of the PMU control unit 31 will be described later.

The management table 41 manages performance information. For example, the management table 41 stores, for each of a plurality of different pieces of performance information, an integrated value of the number of times of occurrence of an event and the number of times of acquisition in association with an average value obtained by averaging operation characteristics of the application 21 at the time of collection. It is sufficient that the operation characteristic of the application 21 is acquired by using, for example, a function of acquiring a CPU pipeline resource use rate of the PMU 61. Note that an example of the management table 41 will be described later.

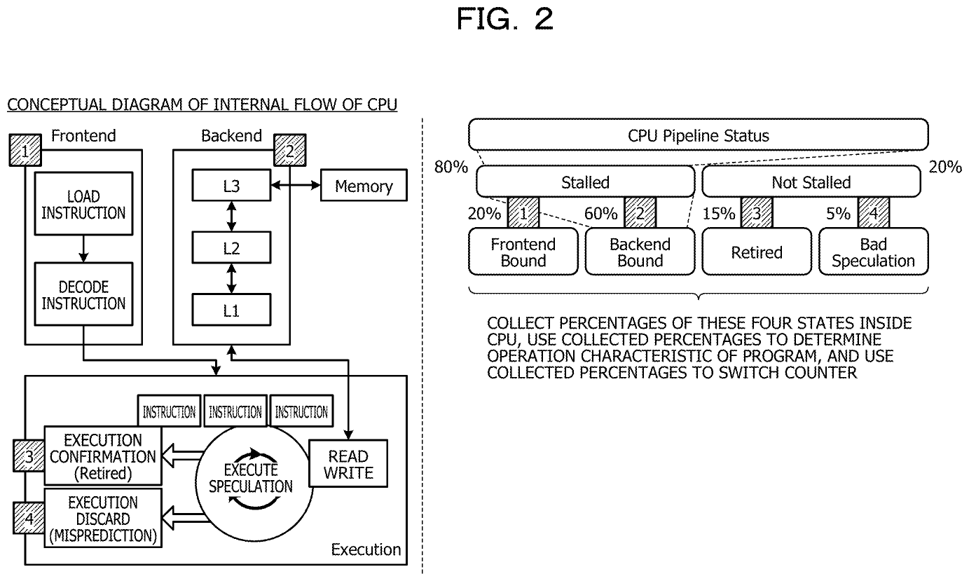

Here, the function of acquiring the CPU pipeline resource use rate of the PMU 61 will be described with reference to FIG. 2. FIG. 2 is a diagram for describing the function of acquiring the CPU pipeline resource use rate of the PMU.

A conceptual diagram of an internal flow of the CPU is illustrated in a left diagram of FIG. 2. As illustrated in the left diagram of FIG. 2, the function of acquiring the CPU pipeline resource use rate classifies the internal flow of the CPU into four states. The four states indicate Frontend, Backend, execution confirmation (Retired), and execution discard (misprediction). The Frontend loads and decodes an instruction and supplies the loaded and decoded instruction to an Execution Unit. The Backend performs cache and memory access in a case where an instruction is data reading or writing. Then, each instruction is speculatively executed in parallel. The execution confirmation (Retired) indicates execution confirmation of an instruction by speculative execution. The execution discard (misprediction) indicates execution discard due to misprediction of a branch caused by speculative execution.

In a right diagram of FIG. 2, the CPU pipeline resource use rate is indicated. The CPU pipeline resource use rate is obtained by counting a resource use rate as a percentage for the four states inside the CPU. For example, the function of acquiring the CPU pipeline resource use rate collects percentages of the four states inside the CPU. Here, the percentages for the four states of the Frontend, the Backend, the execution confirmation (Retired), and the execution discard (misprediction) represent 20%, 60%, 15%, and 5%. The percentages of the four states inside the CPU are included in the CPU pipeline resource use rate. Additionally, the CPU pipeline resource use rate is used to determine the operation characteristic of the application 21 and is used to switch the PMC 610.

Returning to FIG. 1, the state information current value 42 holds a current value of the CPU pipeline resource use rate. For example, the state information current value 42 holds the CPU pipeline resource use rate measured immediately before switching. Note that an example of the state information current value 42 will be described later.

The PMU control unit 31 collects a plurality of pieces of different performance information of the core 60 by using the PMU 61 when the application 21 operating on the core 60 of the CPU 50 is executed. The PMU control unit 31 allocates one piece of performance information to one PMC 610 as an object to be collected, and collects an event that occurs for the performance information by using the PMC 610.

Furthermore, for each piece of the performance information to be collected, the PMU control unit 31 accumulates, in the management table 41, an accumulated value (integrated value) of the number of times of occurrence of an event and the number of times of becoming the object to be collected (the number of times of acquisition) in association with an average value obtained by averaging the operation characteristics of the application 21 at the time of collection. The operation characteristic of the application 21 mentioned here is the CPU pipeline resource use rate. For example, the PMU control unit 31 acquires, from the PMU 61, the CPU pipeline resource use rate when each piece of performance information to be collected is collected as the object to be collected. Then, the PMU control unit 31 calculates an average value of the acquired CPU pipeline resource use rate and a use rate when collection is performed previously as the object to be collected, and updates the average value in the management table 41.

Furthermore, in a case where the number of PMCs 610 is smaller than the total number of the plurality of pieces of performance information, the PMU control unit 31 switches the performance information to be allocated to the PMCs 610 as the object to be collected at regular time intervals.

For example, in a case where the number of times of acquisition of each of the plurality of pieces of performance information is not the same number of times, the PMU control unit 31 selects performance information as a next object to be collected from the plurality of pieces of performance information so as to switch the performance information at regular time intervals so that the number of times of acquisition becomes the same number of times. Then, the PMU control unit 31 allocates the selected performance information to the PMCs 610 in order to switch to the selected performance information.

Then, when the number of times of acquisition of each of the plurality of pieces of performance information becomes the same number of times, the PMU control unit 31 selects, as the next object to be collected, performance information having an average value of the CPU pipeline resource use rate most separated from a current value of the CPU pipeline resource use rate. The current value of the CPU pipeline resource use rate may also be said to be a value of the CPU pipeline resource use rate at the time of measurement immediately before switching. As an example, the PMU control unit 31 compares the current value of the CPU pipeline resource use rate with the average value of the CPU pipeline resource use rate recorded for each piece of performance information. Then, as a result of the comparison, the PMU control unit 31 preferentially selects performance information having the average value of the CPU pipeline resource use rate having the lowest similarity. The performance information having the lowest similarity is preferentially selected for the following reason. It is desirable that collection results (the number of times of event occurrence) of all pieces of performance information are acquired at the same operation characteristic (CPU pipeline resource use rate) of the application 21. This is because performance varies when the operation characteristics of the application 21 are different. Therefore, the PMU control unit 31 preferentially selects performance information having the average value of the CPU pipeline resource use rate (operation characteristic) most separated from the current value (value at the time of measurement immediately before switching) of the CPU pipeline resource use rate (operation characteristic). With this configuration, the PMU control unit 31 may smooth the CPU pipeline resource use rate (operation characteristic) at the time of collection of the performance information. For example, the PMU control unit 31 collects information in a state where the CPU pipeline resource use rate (operation characteristic) is smoothed for any performance information, and may collect the performance information without being affected by an execution status of the application 21. As a result, the PMU control unit 31 may collect the performance information without being affected by the execution status of the application 21.

Note that it is sufficient that switching at regular time intervals is performed by using time division. As an example, in a case where the operating system 20 is Linux (registered trademark), it is sufficient for the PMU control unit 31 to perform processing as follows. For example, it is sufficient for the PMU control unit 31 to switch the performance information to be allocated to the PMCs 610 in a round-robin manner at regular intervals in a unit of several milliseconds by using performance tools for Linux (perf) which is a standard tool of Linux.

[Example of Management Table]

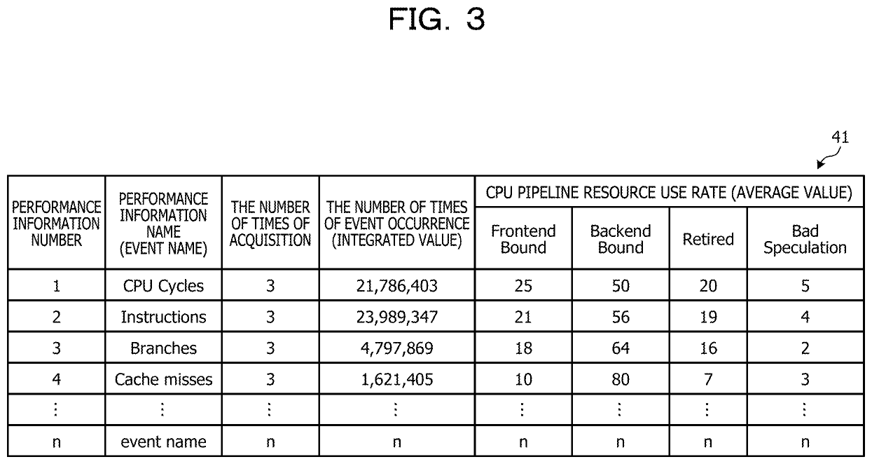

Here, an example of the management table 41 according to the embodiment will be described with reference to FIG. 3. FIG. 3 is a diagram illustrating an example of the management table according to the embodiment. As illustrated in FIG. 3, the management table 41 stores a performance information number, a performance information name, the number of times of acquisition, the number of times of event occurrence (integrated value), and a CPU pipeline resource use rate (average value) in association with each other.

The performance information number is a number that may uniquely identify performance information. The performance information name is a name that may uniquely identify performance information, and is also a name of an event. The number of times of acquisition indicates the number of times of becoming an object to be collected. For example, the number of times of acquisition is the number of times of acquisition (collection) as an object to be collected. The number of times of event occurrence (integrated value) is an integrated value of the number of times of occurrence of an event occurring at the time of collection. The CPU pipeline resource use rate (average value) includes percentages of the four states inside the CPU of the Frontend, the Backend, the Retired, and Bad Speculation, and indicates an average value for the percentages at the time of collection. Note that the Ritired refers to the percentage of the execution confirmation, and the Bad Speculation refers to the percentage of the execution discard (misprediction).

As an example, in a case where the performance information number is “1”, “CPU Cycles” is stored as the performance information name, “3” is stored as the number of times of acquisition, and “21,786,403” is stored as the number of times of event occurrence (integrated value). Additionally, “25(%)” is stored as the Frontend, “50(%)” is stored as the Backnd, “20(%)” is stored as the Retired, and “5(%)” is stored as the Bad Speculation. Furthermore, in a case where the performance information number is “2”, “Instructions” is stored as the performance information name, “3” is stored as the number of times of acquisition, and “23,989,347” is stored as the number of times of event occurrence (integrated value). Additionally, “21(%)” is stored as the Frontend, “56(%)” is stored as the Backnd, “19(%)” is stored as the Retired, and “4(%)” is stored as the Bad Speculation.

[Example of State Information Current Value]

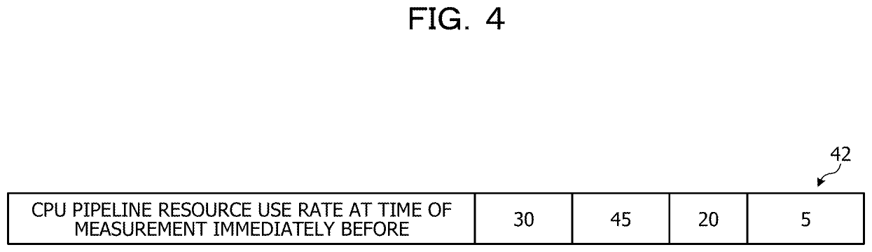

Here, an example of the state information current value 42 according to the embodiment will be described with reference to FIG. 4. FIG. 4 is a diagram illustrating an example of the state information current value according to the embodiment. As illustrated in FIG. 4, the state information current value 42 holds a current value of the CPU pipeline resource use rate. The state information current value 42 is stored in association with the CPU pipeline resource use rate. The CPU pipeline resource use rate includes percentages of the four states inside the CPU of the Frontend, the Backend, the Retired, and the Bad Speculation, and is the CPU pipeline resource use rate at the time of measurement immediately before switching. For example, the CPU pipeline resource use rate indicates a current value of the CPU pipeline resource use rate.

Note that, in a case where the number of times of acquisition of each of the plurality of pieces of performance information is not the same number of times, the PMU control unit 31 selects performance information as a next object to be collected from the plurality of pieces of performance information so as to switch the performance information at regular time intervals so that the number of times of acquisition becomes the same number of times. Then, when the number of times of acquisition of each of the plurality of pieces of performance information becomes the same number of times, the PMU control unit 31 preferentially selects performance information having an average value of the CPU pipeline resource use rate having the lowest similarity with the current value of the CPU pipeline resource use rate. The CPU pipeline resource use rate includes the percentages of the four states. Therefore, it is sufficient that, as the similarity, a square root of a sum of squares of differences in a case where values of the four states are set as a four-dimensional vector is calculated.

For example, it is assumed that (the Frontend, the Backend, the Retired, and the Bad Speculation) indicating the current value of the CPU pipeline resource use rate is (x₁, x₂, x₃, and x₄). It is assumed that (the Frontend, the Backend, the Retired, the Bad Speculation) indicating the average value of the CPU pipeline resource use rate is (y₁, y₂, y₃, and y₄). Then, similarity d(x, y) is calculated by the following Expression (1). Note that the larger d(x, y), the lower the similarity.

[Expression 1]

d(x,y)=\sqrt{(x₁−y₁)²+(x₂−y₂)²+(x₃−y₃)²+(x₄−y₄)²} (1)

As an example, it is assumed that the current value of the CPU pipeline resource use rate is (30, 45, 20, and 5) as illustrated in FIG. 4. It is assumed that the CPU pipeline resource use rate (average value) for each piece of performance information is indicated in the management table 41 of FIG. 3. Then, the similarity of the “CPU Cycles” in a case where the performance information number is “1” is calculated as “7.1”. The similarity of the “Instructions” in a case where the performance information number is “2” is calculated as “14.2”. The similarity of “Branches” in a case where the performance information number is “3” is calculated as “23.0”. The similarity of “Cache misses” in a case where the performance information number is “4” is calculated as “42.4”. Therefore, the PMU control unit 31 preferentially selects the performance information in the order of the performance information numbers “4”, “3”, “2”, and “1”.

[Flowchart of Performance Monitoring Processing]

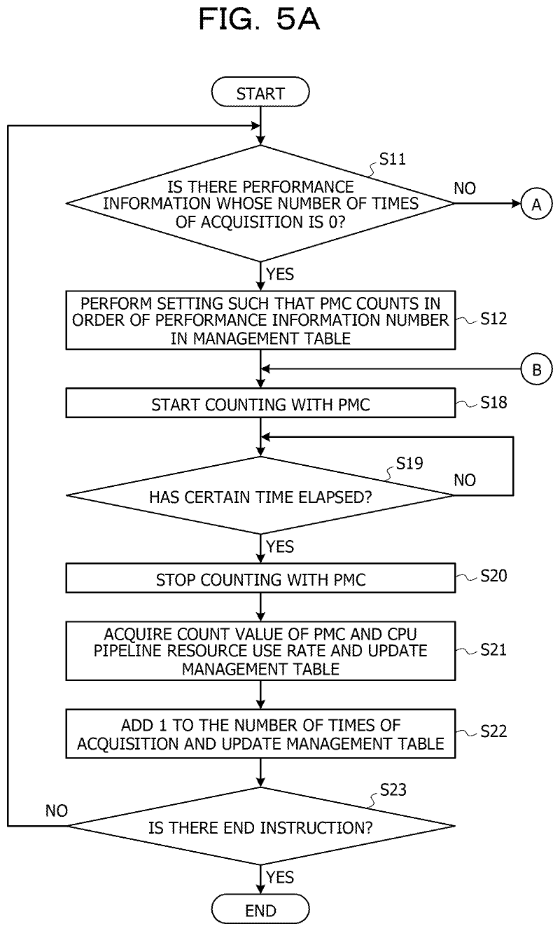

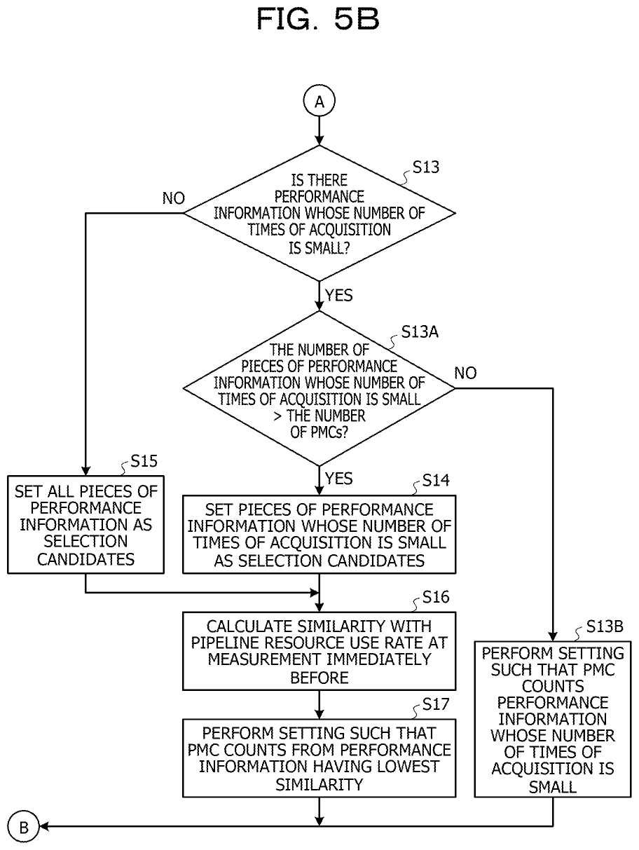

Here, an example of a flowchart of performance monitoring processing according to the embodiment will be described with reference to FIGS. 5A and 5B. FIGS. 5A and 5B are a diagram illustrating an example of the flowchart of the performance monitoring processing according to the embodiment.

The PMU control unit 31 refers to the management table 41 to determine whether or not there is performance information whose number of times of acquisition is 0 (Step S11). In a case where it is determined that there is the performance information whose number of times of acquisition is 0 (Step S11; Yes), the PMU control unit 31 performs setting (allocation) such that the PMC 610 counts the performance information whose number of times of acquisition is 0 in the order of the performance information number in the management table 41 (Step S12). Then, the PMU control unit 31 proceeds to Step S18.

On the other hand, in a case where it is determined that there is no performance information whose number of times of acquisition is 0 (Step S11; No), the PMU control unit 31 refers to the management table 41 to determine whether or not there is performance information whose number of times of acquisition is small when compared with others (Step S13). In a case where it is determined that there is the performance information whose number of times of acquisition is small (Step S13; Yes), the PMU control unit 31 determines whether or not the number of pieces of performance information whose number of times of acquisition is small is greater than the number of PMCs 610 (Step S13A).

In a case where it is determined that the number of pieces of performance information whose number of times of acquisition is small is not greater than the number of PMCs 610 (Step S13A; No), the PMU control unit 31 refers to the management table 41 to perform setting (allocation) such that the PMC 610 counts the performance information whose number of times of acquisition is small (Step S138). Then, the PMU control unit 31 proceeds to Step S18.

On the other hand, in a case where it is determined that the number of pieces of performance information whose number of times of acquisition is small is greater than the number of PMCs 610 (Step S13A; Yes), the PMU control unit 31 refers to the management table 41 to set the pieces of performance information whose number of times of acquisition is small as selection candidates (Step S14). Then, the PMU control unit 31 proceeds to Step S16.

On the other hand, in a case where it is determined that there is no performance information whose number of times of acquisition is small (Step S13; No), the PMU control unit 31 sets all the pieces of performance information as selection candidates since the number of times of acquisition is the same number of times (Step S15). Then, the PMU control unit 31 proceeds to Step S16.

In Step S16, the PMU control unit 31 calculates similarity between the CPU pipeline resource use rate of the selection candidates and the CPU pipeline resource use rate at measurement immediately before (Step S16). For example, the PMU control unit 31 compares the CPU pipeline resource use rate stored in the state information current value 42 with an average value of the CPU pipeline resource use rate of performance information of each selection candidate stored in the management table 41. Then, the PMU control unit 31 calculates, by using Expression (1), similarity between the CPU pipeline resource use rate of the selection candidates and the CPU pipeline resource use rate at measurement immediately before.

Then, the PMU control unit 31 performs setting (allocation) such that the PMC 610 counts from performance information of the selection candidate having the lowest similarity (Step S17). Then, the PMU control unit 31 proceeds to Step S18.

In Step S18, the PMU control unit 31 starts counting with the PMC 610 (Step S18). Then, the PMU control unit 31 determines whether or not a certain time has elapsed (Step S19). In a case where it is determined that the certain time has not elapsed (Step S19; No), the PMU control unit 31 repeats the determination processing until the certain time elapses.

On the other hand, in a case where it is determined that the certain time has elapsed (Step S19; Yes), the PMU control unit 31 stops counting with the PMC 610 (Step S20).

Then, the PMU control unit 31 acquires a count value of the PMC 610 and the CPU pipeline resource use rate, and updates the management table 41 (Step S21). For example, the PMU control unit 31 acquires the count value from the PMC 610 allocated to the object performance information, integrates the count value with the number of times of event occurrence for the object performance information stored in the management table 41, and updates the management table 41. The PMU control unit 31 acquires a current value of the CPU pipeline resource use rate acquired from the PMU 61, calculates an average value with the CPU pipeline resource use rate for the object performance information stored in the management table 41, and updates the management table 41.

Then, the PMU control unit 31 adds 1 to the number of times of acquisition, and updates the management table 41 (Step S22). For example, the PMU control unit 31 adds 1 to the number of times of acquisition for the object performance information stored in the management table 41, and updates the added value in the management table 41.

Then, the PMU control unit 31 determines whether or not there is an end instruction (Step S23). In a case where it is determined that there is no end instruction (Step S23; No), the PMU control unit 31 proceeds to Step S11 to perform the next processing.

On the other hand, in a case where it is determined that there is the end instruction (Step S23; Yes), the PMU control unit 31 ends the performance monitoring processing.

### Effects of Embodiment

In the embodiment described above, in the collection of the plurality of pieces of performance information of the core 60 when the application 21 operating on the core 60 is executed, the information processing apparatus 1 associates and accumulates the operation characteristic of the application 21 for each of the plurality of pieces of performance information. In a case where the number of performance monitoring counters (PMCs) 610 included in the core 60 is smaller than the total number of the plurality of pieces of performance information, the information processing apparatus 1 selects the performance information having the operation characteristic of the application 21 most separated from the current value of the operation characteristic of the application 21 from the plurality of pieces of performance information, and allocates the performance information to the PMC 610. According to such a configuration, the information processing apparatus 1 may collect information obtained by smoothing the operation characteristic of the application 21 for any of the plurality of pieces of performance information, and may collect the performance information without being affected by the execution status of the application 21.

In the embodiment described above, the information processing apparatus 1 further associates and accumulates the number of times of acquisition of the event related to the plurality of pieces of performance information. Then, the information processing apparatus 1 selects the next object to be collected so that the number of times of acquisition of each of the plurality of pieces of performance information becomes the same number of times, and when the number of times of acquisition of each of the plurality of pieces of performance information becomes the same number of times, selects the performance information having the average value of the operation characteristic of the application 21 that is most separated from the current value of the operation characteristic of the application 21, and sets the performance information as the next object to be collected. According to such a configuration, the information processing apparatus 1 may smooth a difference in the operation characteristic of the application 21 when a plurality of different pieces of performance information is collected, and collect the plurality of different pieces of performance information without being affected by the operation characteristic of the application 21.

Furthermore, in the embodiment described above, the information processing apparatus 1 preferentially allocates the performance information to the PMC 610 according to the similarity between the current value of the operation characteristic of the application 21 and the average value of the operation characteristics of the application 21 for each of the plurality of pieces of performance information. According to such a configuration, the information processing apparatus 1 may preferentially allocate the performance information to be allocated to the PMC 610 next by using the similarity.

Furthermore, in the embodiment described above, the operation characteristic of the application 21 is the CPU pipeline resource use rate of the PMU 61. With this configuration, the information processing apparatus 1 may collect a plurality of pieces of different performance information without being affected by the CPU pipeline resource use rate when the application 21 is executed.

[Others]

In the embodiment, it has been described that the performance monitoring program 30 is provided in the operating system 20, and the performance monitoring program 30 monitors the plurality of types of performance of the core 60 on which the application 21 is operated by using the PMU 61. However, the performance monitoring program 30 is not limited to the inside of the operating system 20, and may be outside the operating system 20, and it is sufficient that the performance monitoring program 30 is a program for the operating system 20.

Furthermore, in the embodiment, it has been described that the four states of the CPU pipeline resource use rate of the PMU 61 are used to determine the operation characteristic of the application 21. However, another state of the CPU pipeline resource use rate of the PMU 61 may be used to determine the operation characteristic of the application 21. Furthermore, the determination of the operation characteristic of the application 21 is not limited to using the CPU pipeline resource use rate of the PMU 61, and another method may be used.

Furthermore, each illustrated component of the performance monitoring program 30 included in the information processing apparatus 1 does not necessarily have to be physically configured as illustrated in the drawings. For example, specific aspects of separation and integration of the respective devices are not limited to those illustrated, and all or a part thereof may be functionally or physically separated and integrated in any unit according to various loads, use statuses, or the like. For example, the PMU control unit 31 may be separated into a functional unit that collects, by using the PMC 610, information regarding performance information to be collected, a functional unit that accumulates the collected information in the management table 41, and a functional unit that switches performance information to be allocated to the PMC 610 as an object to be collected at regular periods. A storage unit (not illustrated) that stores the management table 41, the state information current value 42, and the like may be coupled as an external device of the information processing apparatus 1 via a network.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a performance monitoring program for causing a computer to execute processing comprising:
in collection of a plurality of pieces of performance information of a processor when a program that operates in the processor is executed, associating and accumulating an operation characteristic of the program for each of the plurality of pieces of performance information; and
selecting, in a case where the number of performance monitoring counters (PMCs) included in the processor is smaller than a total number of the plurality of pieces of performance information, performance information that has the operation characteristic of the program most separated from a current value of the operation characteristic of the program from the plurality of pieces of performance information, and allocating the performance information to the PMC.

2. The non-transitory computer-readable recording medium according to claim 1, wherein,
in the processing of accumulating, the number of times of acquisition of an event related to the plurality of pieces of performance information is further associated and accumulated, and
in the processing of allocating, a next object to be collected is selected such that the number of times of acquisition of each of the plurality of pieces of performance information becomes the same number of times, and when the number of times of acquisition of each of the plurality of pieces of performance information becomes the same number of times, the performance information that has the average value of the operation characteristic of the program most separated from the current value of the operation characteristic of the program is selected and set as the next object to be collected.

3. The non-transitory computer-readable recording medium according to claim 2, wherein,
in the processing of allocating, the performance information is preferentially allocated to the PMC according to similarity between the current value of the operation characteristic of the program and the average value of the operation characteristic of the program for each of the plurality of pieces of performance information.

4. The non-transitory computer-readable recording medium according to claim 1, wherein
the operation characteristic of the program is a central processing unit (CPU) pipeline resource use rate of a performance monitoring unit (PMU).

5. A performance monitoring method comprising:
in collection of a plurality of pieces of performance information of a processor when a program that operates in the processor is executed, associating and accumulating an operation characteristic of the program for each of the plurality of pieces of performance information; and
selecting, in a case where the number of performance monitoring counters (PMCs) included in the processor is smaller than a total number of the plurality of pieces of performance information, performance information that has the operation characteristic of the program most separated from a current value of the operation characteristic of the program from the plurality of pieces of performance information, and allocating the performance information to the PMC.

6. An information processing apparatus comprising:
a memory; and
a processor coupled to the memory and configure to:
in collection of a plurality of pieces of performance information of a processor when a program that operates in the processor is executed, associate and accumulating an operation characteristic of the program for each of the plurality of pieces of performance information; and
select, in a case where the number of performance monitoring counters (PMCs) included in the processor is smaller than a total number of the plurality of pieces of performance information, performance information that has the operation characteristic of the program most separated from a current value of the operation characteristic of the program from the plurality of pieces of performance information, and allocating the performance information to the PMC.
